(19) United States
(12) Patent Application Publication
(10) Pub. No.: US 2015/0213408 A1
(43) Pub. Date: Jul. 30, 2015

(54) System and Method for Crowd Sourcing Product Development

(71) Applicant: Ke Rong Ruan, Surrey (CA)

(72) Inventor: Ke Rong Ruan, Surrey (CA)

(73) Assignee: INNOKING (XIAMEN) NETWORK LTD, XIAMEN (CN)

(21) Appl. No.: 14/609,257

(22) Filed: Jan. 29, 2015

Related U.S. Application Data
(60) Provisional application No. 61/933,045, filed on Jan. 29, 2014.

(51) Int. Cl. G06Q 10/10

(52) U.S. Cl. CPC G06Q 10/101

(57) ABSTRACT

A system and method for crowd sourcing product development. A product idea submission form for a product idea is submitted through a product idea submission module by an innovator user. The product idea submission form is decompiled into a plurality of tasks according to the product idea, wherein each of the tasks has a unique identification number. The plurality of tasks is displayed through a release window module, wherein engineer users can view the tasks and place a plurality of bids on each of the tasks, each of the bids including a cost estimate, time estimate, and initial technical schematic. An administrator user reviews the bids and makes a bid selection for a particular bid from the plurality of bids for each of the tasks. Final completed task information is retrieved for each of the tasks and compiled into a product development process package then sent to the innovator user.

The current application claims a priority to the U.S. Provisional Patent application Ser. No. 61/933,045 filed on Jan. 29, 2014.

### FIELD OF THE INVENTION

The present invention relates generally to product development processes, which are often utilized by companies attempting to develop new products to market to consumers. More specifically, the present invention is a system and method for efficiently and securely crowd sourcing product development tasks in an effort to speed up product development time and reduce costs and resource consumption, thereby making the product development process more readily performable by small companies and individual innovators.

### BACKGROUND OF THE INVENTION

Striving to increase the profit of companies and the income of individuals is inextricably linked to the development of new products and technological innovation. New products which solve previously unsolved problems in common life, or which provide superior solutions when compared to older products are often chosen by consumers. Additionally, new technology can sometimes lead to additional problems which themselves must be solved by some technical innovation. Thus, in a way, technological innovation drives itself as the more technology and knowledge we accumulate, the more knowledge and technology we need to streamline and improve our lives. As a result of the eternal forwards march of technology, companies are always trying to find new ways to improve their products, or to create entirely new products which will be attractive for purchase by large numbers of consumers. The art of developing new products or items is of great importance to a company's continued success and survival within the free market. And thus, a great deal of time and effort have been spent to create methods which enable efficient and reliable creation new products which will be successful within the free market. Within the realm of engineering, the process of creating new products ideas and products is commonly referred to as the product development process, or PDP for short. The PDP is a fairly involved process which requires a large amount of capital and a skilled workforce in order to successfully operate. This is typically of no issue to a large company which has thousands of employees, millions of dollars in capital, and potential investors with which to fuel their push for developing new products. Unfortunately, operating the PDP can be rather difficult for a small business with very limited investor backing and a small employee pool from which to draw skilled individuals. There is a need for a new PDP which can allow small companies, or potentially even individual innovators to develop their ideas into fully fledged and marketable products.

The present invention has been created in response to the need for a novel PDP which can allow small companies and individuals to perform product development effectively despite their extremely limited resources. The present invention may also be useful for large companies who wish to maximize the quantity of new products they are developing at any given time, as the present invention may give them access to additional resources to utilize in their product development efforts. The present invention is a system and method for crowd sourcing product development which is intended to make use of the modern business technique known as crowd sourcing. It is an object of the present invention to provide a system and a method which make it possible for streamlined crowd sourcing of the PDP. This effectively makes the PDP available to virtually any innovator, be they an individual inventor or a large corporate entity. It is an object of the present invention to break down each product idea into a plurality of tasks which can then be bid on by various different engineers who wish to perform the task. In this manner, the innovator is provided with an immense skill base to utilize in development of their particular product idea. The unique way in which the present invention breaks down the product idea into individual tasks prevents external parties from determining what that product idea is. This is similar to the functioning of a cell based command structure; each engineer working on a task for a particular product idea does not have any information about other tasks relating to that product, and thus they cannot determine the true nature of the product idea to steal it for themselves. Thus, the present invention enables secure and efficient crowd sourcing of new and innovative product ideas.

### BRIEF DESCRIPTION OF THE DRAWINGS

FIG. 1 is a flowchart depicting the overall method for crowd sourcing product development;

FIG. 2 is a flowchart thereof, further depicting steps for decompiling a product idea submission form into a plurality of tasks;

FIG. 3 is a flowchart thereof, further depicting steps for decompiling the product idea submission form according to decompiling instructions provided by an administrator user;

FIG. 4 is a flowchart thereof, further depicting steps in the event the product idea submission form is manually decompiled by the administrator user;

FIG. 5 is a flowchart thereof, further depicting steps for compiling final completed task information for each of the plurality of tasks into a product development process package; and

FIG. 6 is a flowchart thereof, further depicting steps for compiling the final completed task information for the plurality of tasks according to compiling instructions provided by the administrator user.

FIG. 7 is a diagram depicting the plurality of tasks displayed through a release window module, wherein each of the plurality of tasks is assigned a unique identification number.

### DETAIL DESCRIPTIONS OF THE INVENTION

All illustrations of the drawings are for the purpose of describing selected versions of the present invention and are not intended to limit the scope of the present invention.

The present invention is a system and method for crowd sourcing product development that is designed to provide product development process (PDP) services to a company or an individual at a greatly reduced cost in money and other resources such as employees, time, and raw materials. The present invention comprises a method for facilitating the PDP via crowd sourcing and a system through which the method is implemented. The system of the present invention comprises all of the physical and conceptual components which are necessary for the operation of the method for facilitating the PDP via crowd sourcing. The system of the present invention comprises a server, an administrator user account 10, an innovator user account 20, a plurality of engineer user accounts, and a website.

The server of the present invention provides hosting and data storage services which are necessary for the operation of the website. The server comprises all of the necessary computing power, physical data storage, and network connections which are needed for the operation of the website. The exact technical specifications of the server may vary in the final embodiment of the present invention depending upon the specific requirements of hosting the website, including data storage requirements, processing needs, and volume of network traffic. Typically, the size and power of the server must increase as these three metrics increase. It is also possible for a network of servers or similar devices to be used.

The administrator user account 10 is associated with an administrator user, wherein the administrator user is responsible for managing the operation of the website. The administrator user is also responsible for maintaining the website and performing any necessary routine tasks in order to keep the website operating continuously. The administrator user account 10 grants the administrator user access to the various different administrative functions of the website, wherein the administrator user has a specific login for accessing the administrator user account 10. It is also important to note that the administrator user denotes a particular type of user, and that in actuality there may be a plurality of users who fall within the administrator user type such that each of said users can work as a team to fully manage and operate the present invention. Additionally, each of said users may have individual administrator user account 10s for accessing functions supported by the server and website.

A second type of user is an innovator user, or the individual that has a product idea that needs to be developed. The innovator user is provided access to functions of the website through an innovator user account 20, wherein the innovator user can upload details in relation to the product idea to the server through the innovator user account 20. Similar to the administrator user account 10, the innovator user account 20 is accessed by the innovator user using a specific login designated by the innovator user. Depending on the implementation of the present invention, it is possible for the administrator user and the innovator user to be one and the same, or for the administrator user and the innovator user to be in some way affiliated with one another. If the innovator user is not affiliated with the administrator user then the innovator user may be required to pay some fee to grant the innovator user access to the present invention, or the innovator user may pay with partial property rights to the product idea submitted through the present invention.

Each of the plurality of engineer user accounts is associated with an engineer user, the third type of user. The engineer user constitutes a technically minded and highly skilled individual who provides relevant skills to contribute to the product idea being crowd sourced by the innovator. Similar to the administrator user and the innovator user, the engineer user has a specific user login and password which grants the engineer user access to a particular engineer account from the plurality of engineer user accounts. The particular engineer account may contain information such as the personal skills of the engineer user, the name and location of the engineer user, and any tasks which the engineer user is currently accountable for. The engineer user accumulates tasks via the website in the operation of the method of the present invention, wherein the engineer user may be accountable for one or more tasks at any given time. A historical record of any tasks the engineer user has completed in the past and the amount of money the engineer user was paid for the completion of each task is available through the particular engineering account. Additionally, the particular engineer account must also contain information about some form of monetary account such that funds can be transferred to the engineer user as compensation for successful completion of a given task.

The website is a very important component of the present invention as it allows the engineer user to access various different functions of the present invention. The most notable function being the ability of the engineer user to browse through tasks and place a bid on said tasks in an effort to have a task assigned to them for completion. The website comprises a network connection and a user interface. The network connection enables the website to be accessed via any internet browser. The user interface represents the way in which the tools for carrying out the various functions of the website are visually arranged such that they can be accessed and utilized by the engineer user. The user interface comprises a product idea submission module 40, a release window module 42, and a virtual research and development module 44.

The product idea submission module 40 exists to allow the innovator user to submit product ideas to the present invention. The product submission module may accept product ideas in a variety of different ways such as digital files including but not limited to pictures, videos, and text document files. Additionally, it may be possible for the innovator user to submit the product idea by mail, wherein the administrator user receives a physical copy of the product idea details. The product idea details can then be scanned into a digital form by the administrator user. The product idea details in the digital form are then stored on the server, wherein the product idea details in the digital form are received by the idea submission module through the administrator user account 10.

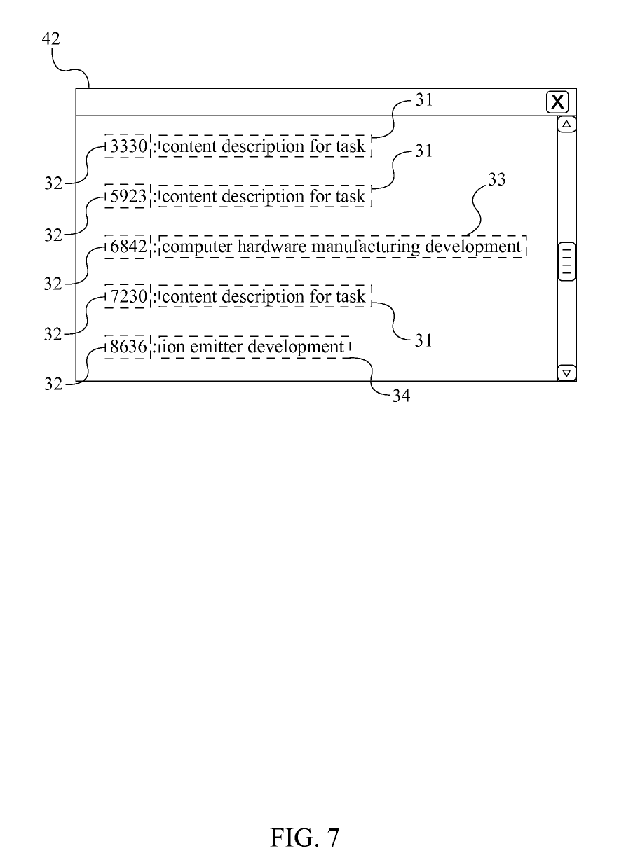

The release window module 42 is very important as it displays a variety of information to the engineer user. Most notably, the release window module 42 displays product ideas or a plurality of tasks 31 which have been broken down from each of the product ideas submitted by an innovator user. Each of the product ideas and each of the plurality of tasks 31 for a product idea must be completed by an engineer user. In reference to FIG. 7, if a product idea is broken down into the plurality of tasks 31, then each of the plurality of tasks 31 is assigned a unique identification number 32. The unique identification number 32 enables the system to track which product idea each of the plurality of tasks 31 belongs to. However, the random nature of the unique identification number 32 prevents the engineer user from determining which product idea the task is part of, such that the engineer user cannot attempt to steal the product idea. Additionally, each of the plurality of tasks 31 is accompanied by a complete description of the work that must be done such that the engineer user can determine whether or not to pursue a particular task from the plurality of tasks 31.

The release window module 42 organizes each of the plurality of tasks 31 into a comprehensive list that can be searched and filtered by the engineer user, such that the engineer user can readily find the tasks that match the skills of the engineer, and thus are worth time pursing in order to secure the task for themselves. This is directly related to a subcomponent of the release window module 42; an engineer bid module. The engineer bid module allows the engineer user to effectively place a bid on any given task which they may discover through the use of the release window module 42. Each bid comprises a cost estimate 51, a time estimate 52, and an initial technical schematic 53 of how the engineer user intends to approach a solution to the particular task. Each bid may additionally include whether or not the engineer user plans to work alone or in a group, whether or not the engineer user has his or her own facilities to use, and what times the engineer user is available to work on the product idea. The engineer bid module also allows the engineer user to view any tasks which they have placed a bid on. Furthermore, the engineer user is informed via communications methods if any of the bids placed by the engineer user have been accepted. Notifications for accepted bids are also displayed in the engineer bid module such that the engineer user is aware of which tasks the engineer user is now responsible for completing.

The virtual research and development module 44 enables the engineer user to keep track of all active tasks for which the engineer user is currently accountable. The virtual research and development module 44 may also offer support tools such as data storage and communications services. This can be important as the engineer user may elect to work on a particular task with several other engineer users who are not nearby one another, thereby forcing the engineer users to communicate electronically. Using the research and development module 44, the engineer user can exchange information with other engineers working on the particular task, and keep track of their own progress by periodically submitting updates through the research and development module 44. The virtual research and development module 44 also serves as the modus by which final completed task information 70 is submitted to the system, such that the final completed task information 70 can be utilized by the innovator user. Thus, the submission of completed tasks to the system is streamlined and efficient through use of the research and development module 44.

The method of the present invention comprises all of the necessary ordered steps which are carried out in order to crowd source the product idea of an innovator user. The method of the present invention may be subject to change in the final embodiment of the present invention as the exact order in which the steps are carried out may change and still allow the present invention to operate as intended. The following is a description of the steps and PDP in the preferred embodiment of the present invention.

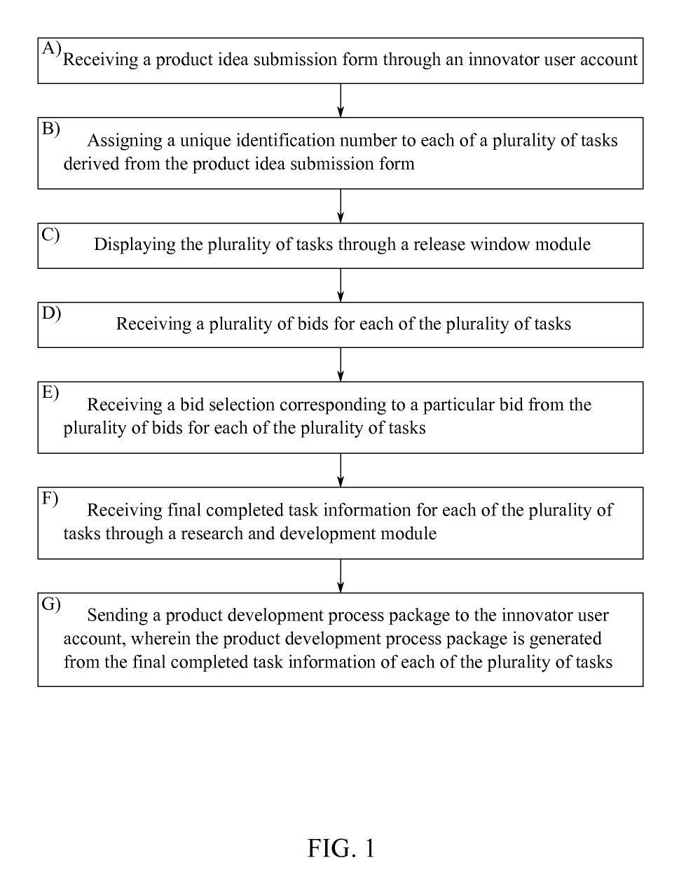

In reference to FIG. 1, the innovator user logs in to the innovator user account 20 using the specific login designated by the innovator user. The innovator user can then submit a product idea using a product idea submission form 30. The product idea submission form 30 can be implemented in multiple ways. In one method, the product idea submission form 30 is displayed through the product idea submission module 40 and includes a plurality of data fields in which the innovator user is able to enter details for the product idea. Once complete, the product idea submission form 30 is saved and uploaded to the server. The details for the product idea may include but are not limited to a deadline for completing research and development for the product idea, technical requirements, quantitative targets, and the total cost budgeted for research and development of the product idea.

The innovator user can also choose not to include the cost budgeted for the product idea, in which case the field is left blank when the product idea is displayed through the release window module 42, or a message such as ‘waiting for quote’ is displayed. This is beneficial to the innovator user, if the innovator user cannot decide on the funds that will be needed to complete the PDP for the product idea. The cost for completing the PDP for the product idea is then determined by the bids that are placed by the engineer users. Alternatively, if the administrator user is versed in the field of the product idea and is given permission by the innovator user, then the administrator user may determined the cost to be displayed for the product idea.

In another method, the details for the product idea are uploaded to the server in a supported file format through the product idea submission module 40. Once the details for the product idea are uploaded, the product idea submission form 30 is appropriately constructed by analyzing the details of the product idea. The details of the product idea may also be analyzed manually by the administrator user, wherein the product idea submission form 30 is then generated by the administrator user and stored on the server through the administrator user account 10.

Once the product idea is received through the product idea submission module 40, the administrator user may assist the innovator user in obtaining intellectual property rights for the product idea. This may include preparing documents and filing applications for patents in one or more countries on behalf of the innovator user for either the entirety of the product idea or for sub-parts of the product idea. If the innovator user already has patent rights over the product idea, then the intellectual property rights must be empowered to the administrator user, such that the administrator user can assist in facilitating the PDP of the product idea. The administrator user may require the innovator user to assign partial rights over the patent to the administrator user, may require a percentage of profits gained from the product idea, etc.

If intellectual property rights for the product idea are secured, then the entirety of the product idea may be published through the release window module 42. The details for the product idea are then displayed through the release window module 42, wherein the engineer users may view and bid on the product idea. The system of the present invention then receives a plurality of bids 50 for the product idea through the engineer bid module. Each of the plurality of bids 50 includes a cost estimate 51, a time estimate 52, and an initial technical schematic 53 for completing the PDP for the product idea. The initial technical schematic 53 submitted by each engineer user is only viewable by the administrator user, however, the cost estimate 51 and the time estimate 52 are publicly displayed to the other engineer users through the release window module 42. This ensures that the plurality of bids 50 remains in a feasible range of the parameters set by the innovator user and that each of the plurality of bids 50 is fair for both parties.

In reference to FIG. 1, if intellectual property rights are not secured for the product idea, then the product idea is deconstructed into a plurality of tasks 31. Each of the plurality of tasks 31 is then assigned a unique identification number 32 through the system of the present invention, wherein the unique identification number 32 for each of the plurality of tasks 31 is randomly generated. Each of the plurality of tasks 31 is then published through the release window module 42 along with the unique identification number 32, wherein the each of the engineer users can view and bid on the plurality of tasks 31. Each of the plurality of tasks 31 may also be given an obscure title as to further distance the plurality of tasks 31 from each other, such that the plurality of tasks 31 cannot be pieced together to discover the entirety of the product idea. The system of the present invention then receives a plurality of bids 50 for each of the plurality of tasks 31 through the engineer bid module.

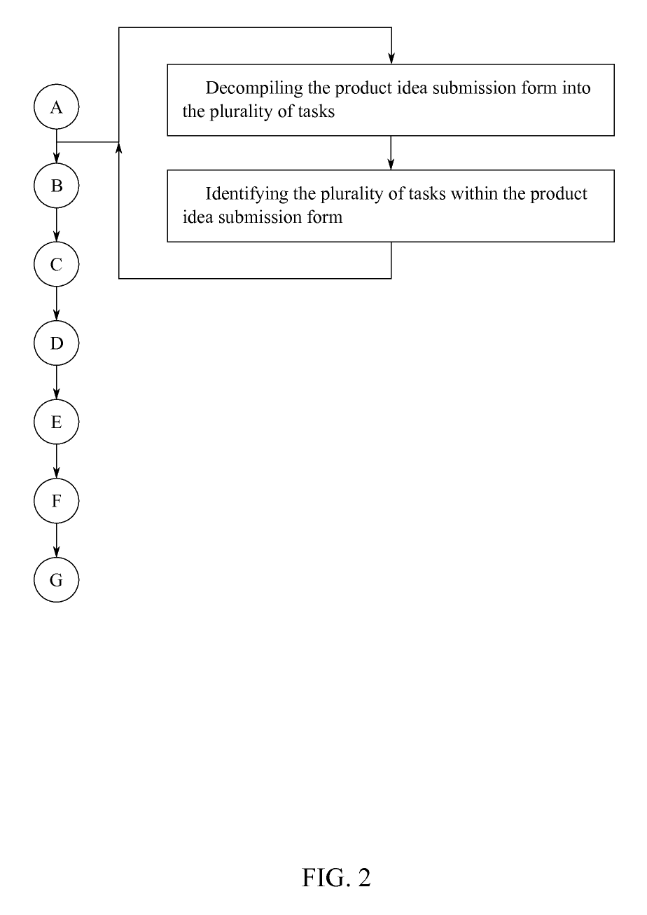

The product idea can be deconstructed into the plurality of tasks 31 in a number of ways. In reference to FIG. 2, in one embodiment of the present invention, the product idea is deconstructed into the plurality of tasks 31 by the system of the present invention, wherein the plurality of tasks 31 is identified within the product idea submission form 30. The plurality of tasks 31 may be identified using a search algorithm, or the product idea submission form 30 may be formatted into sections such that each of the plurality of tasks 31 is submitted in a different section of the product idea submission form 30. Once the plurality of tasks 31 is identified within the product idea submission form 30, then the system decompiles the product idea submission form 30 into the plurality of tasks 31 to be displayed through the release window module 42.

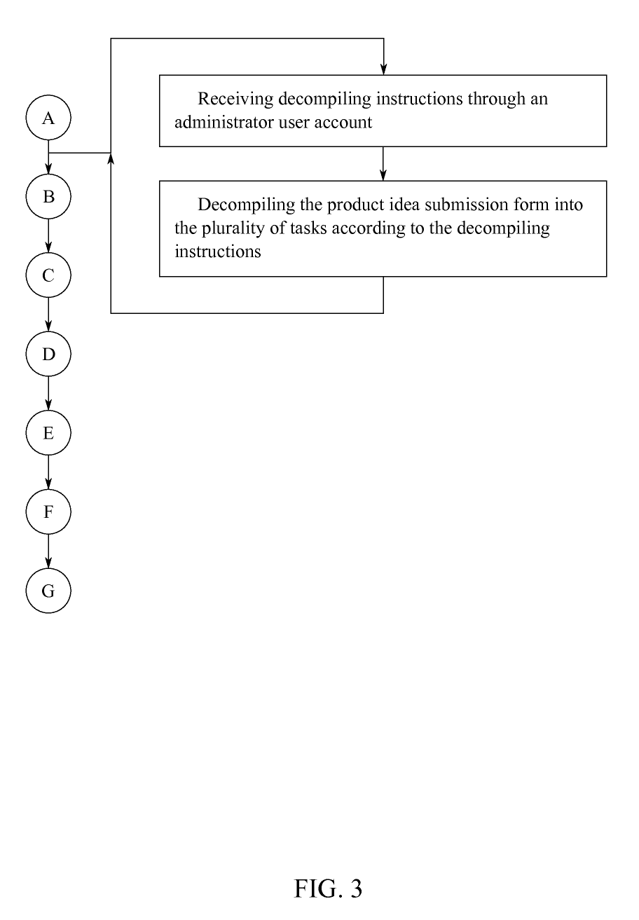

In reference to FIG. 3, in another embodiment of the present invention, the administrator user provides decompiling instructions through the administrator user account 10, wherein the decompiling instructions may vary for each product idea submitted. The decompiling instructions dictate to the system of the present invention the method in which the product idea submission form 30 should be deconstructed into the plurality of tasks 31. Upon receiving the decompiling instructions, the system decompiles the product idea submission form 30 into the plurality of tasks 31 according to the decompiling instructions.

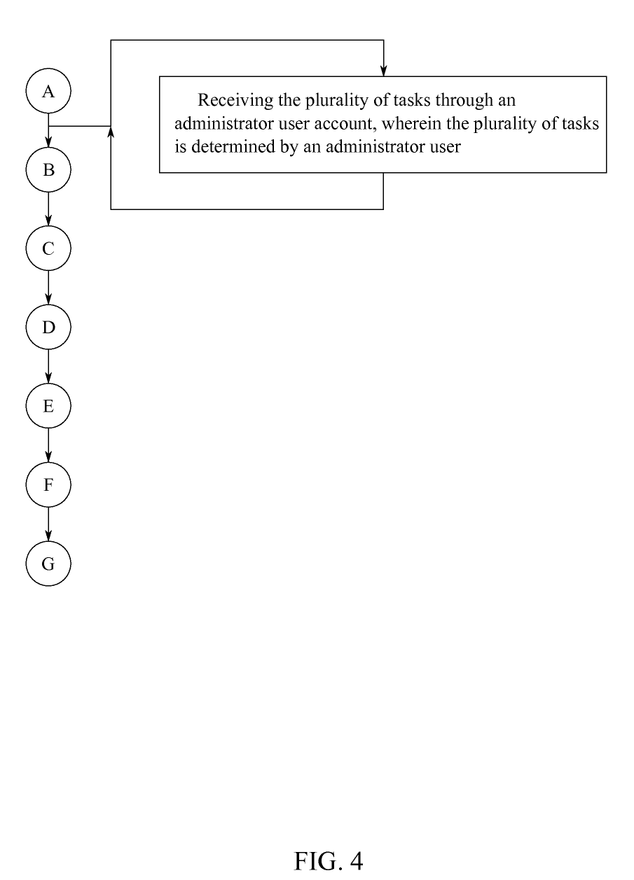

In reference to FIG. 4, in yet another embodiment of the present invention, the product idea submission form 30 is broken into the plurality of tasks 31 entirely by the administrator user. The administrator user retrieves the product idea submission form 30 and manually reviews and separates the plurality of tasks 31 within the product idea submission form 30. Each of the plurality of tasks 31 for the product idea submission form 30 is then entered into the system by the administrator user, wherein the system receives the plurality of tasks 31 and displays the plurality of tasks 31 through the release window module 42.

It is also possible for the engineer user to recommend another engineer user through the research and development module 44. If the engineer user views a task in the research and development module 44 but knows another engineer user that may be better suited to the task, then the engineer user can elect to recommend the other engineer user for the task. The engineer user may directly recommend the task to the other engineer user, or the recommendation may be made through the administrator account. The engineer user making the recommendation may be awarded prize or compensation for making the recommendation if the recommended engineer user has the winning bid.

In reference to FIG. 1, once the plurality of bids 50 for each of the plurality of tasks 31 (or for the product idea as a whole) is received by the system, the administrator user reviews each of the plurality of bids 50 for the best bid. The administrator user can review the cost estimate 51, the time estimate 52, and the initial technical schematic 53 of each of the plurality of bids 50, along with any other pertinent information provided though the bidding process in order to determine the best bid. When the administrator user has determined the best bid, the administrator user places a bid selection 60 corresponding to a particular bid 54 from the plurality of bids 50 for each of the plurality of tasks 31 (or for the product idea as a whole). Upon receiving the bid selection 60 through the administrator user account 10, the system of the present invention sends a notification to the engineer user of the particular bid 54 and the specific task for which the particular bid 54 was made is added to the research and development module 44 for the engineer user.

When the engineer user who made the particular bid 54 is selected, the engineer user may elect to work on the specific task alone or with other engineer users. If the engineer user is working in a group, then the specific task (or the product idea as a whole) is added to the research and development module 44 for each of the other engineer users collaborating with the engineer user who placed the particular bid 54. The research and development module 44 facilitates communication between the engineer users working on a particular task or product idea, wherein only engineer users who are working together are aware of each other and able to communicate with one another. Such communication methods facilitated by the research and development module 44 may include but are not limited to voice of internet protocol, email, or instant messaging.

In reference to FIG. 1, once the specific task is completed by the engineer user (or team of engineer users), the engineer user submits final completed task information 70 to the system of the present invention through the research and development module 44. The system of the present invention receives the final completed task information 70 for each of the plurality of tasks 31 (or the product idea as a whole) in this manner in order to gather all information needed to develop the product idea. A product development process package 80 is then generated from the final completed task information 70 of each of the plurality of tasks 31 and the product development process package 80 is then sent to the innovator user account 20 by the system of the present invention.

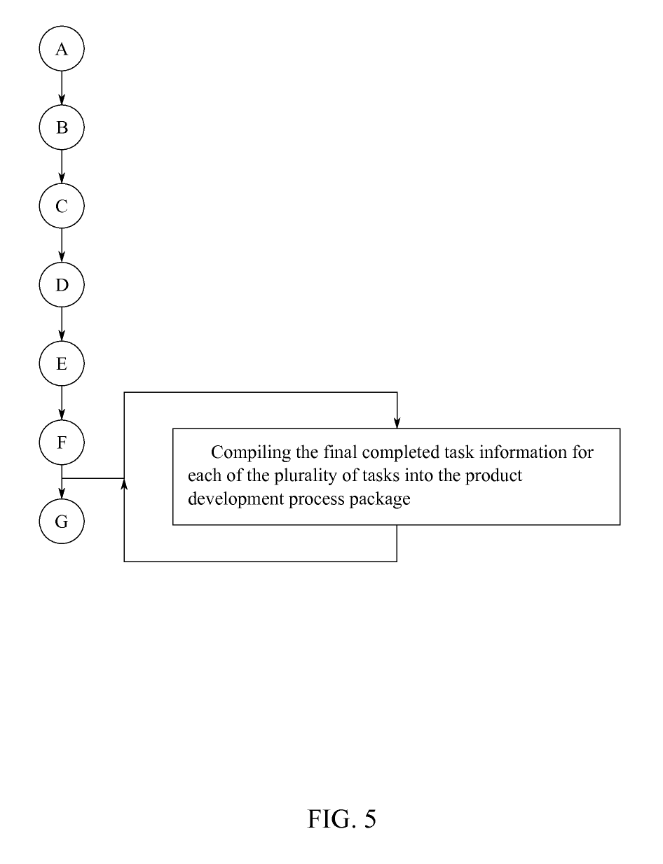

The product development process package 80 may be generated in a number of ways. In reference to FIG. 5, in the preferred embodiment of the present invention, the system of the present invention compiles the final completed task information 70 for each of the plurality of task into the product development process package 80 using a compiling algorithm or by ordering the final completed task information 70 for each of the plurality of tasks 31 in the same order defined by the product idea submission form 30.

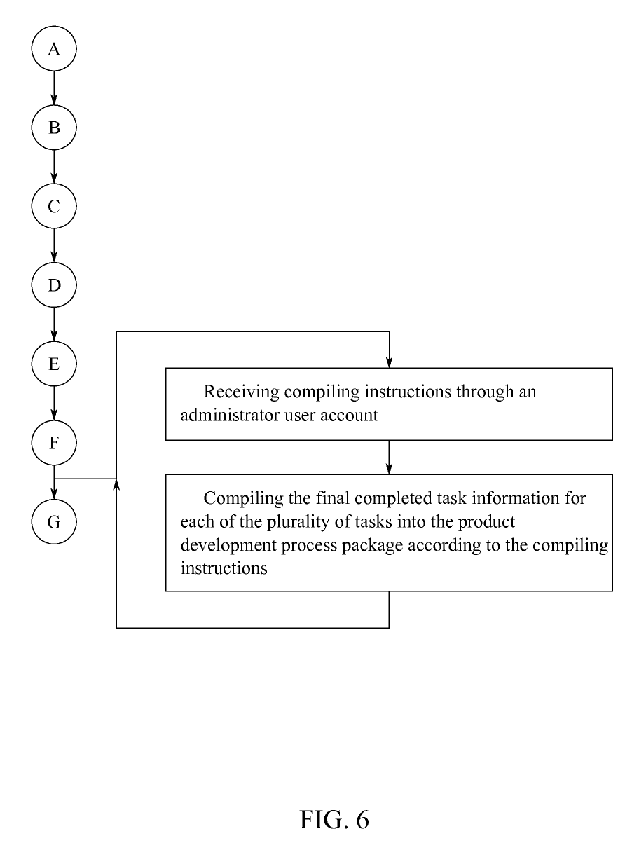

In reference to FIG. 6, in another embodiment of the present invention, the system of the present invention receives compiling instructions through the administrator user account 10, wherein the compiling instructions are defined by the administrator user. The compiling instructions dictate to the system of the present invention the method in which the final completed task information 70 for each of the plurality of tasks 31 should be combined into the product development process package 80. Upon receiving the compiling instructions, the system compiles the final completed task information 70 for each of the plurality of tasks 31 into the product development process package 80 according to the compiling instructions.

In yet another embodiment of the present invention, the product development process package 80 is completely generated by the administrator user. The administrator user reviews the final completed task information 70 for each of the plurality of tasks 31 and then constructs the product development process package 80 in the desired manner. Once the product development process package 80 is generated by the administrator user, the product development process package 80 is uploaded to the system of the present invention through the administrator user account 10.

Upon submitting the final completed task information 70, the engineer user is compensated by the system for the cost of the work. Compensation may require final approval of the final completed task information 70 by the administrator user and/or the innovator user in order to ensure that the work is fully and properly completed. Upon verification of the final completed task information 70, the system allocates funds from the innovator user to the engineer user using payment information and methods specified within the innovator user account 20 and the engineer user account respectively. The engineer user is allocated funds according to the cost estimate 51 provided in the particular bid 54, unless further funds were needed or agreed upon by the innovator user.

The following is to present a specific example case in which the product idea is for a computer mouse which emits negative oxygen ions. The innovator user submits the product idea submission form 30 through the product idea submission module 40, wherein the product idea submission form 30 details a computer mouse that will automatically release negative oxygen ions upon being powered on. The administrator views the product idea submission and upon seeing that the product idea is not protected by a patent, judges the possibility of obtaining intellectual property rights over the product idea.

The product idea is then broken down by the system into the plurality of tasks 31. In this case the plurality of tasks 31 is specifically a first task 33 and a second task 34. The first task 33 for developing the technology for manufacturing the mouse and the second task 34 for developing the negative oxygen ion emitter components. In reference to FIG. 7, the system then assigns a unique identification number 32 to the first task 33 and the second task 34, and displays the first task 33 and the second task 34 through the release window module 42 along with the plurality of tasks 31 for other product ideas.

The bidding process then begins for both the first task 33 and the second task 34. A first engineer user, a second engineer user, and a third engineer user place bids on the first task 33, while a fourth engineer user, a fifth engineer user, and a sixth engineer user place bids on the second task 34. Upon reviewing the plurality of bids 50 for both the first task 33 and the second task 34, the administrator user selects the particular bid 54 of the second engineer user for the first task 33 and the particular bid 54 of the sixth engineer user for the second task 34. The first task 33 is then added to the task queue in the research and development module 44 of the second engineer user, while the second task 34 is added to the task queue in the research and development module 44 for the sixth engineer user.

Once the second engineer completes the first task 33, the second engineer user submits the final completed task information 70 for the first task 33 through the research and development module 44. Similarly, once the sixth engineer completes the second task 34, the sixth engineer user submits the final completed task information 70 for the second task 34 through the research and development module 44. Upon receiving the final completed task information 70 for both the first task 33 and the second task 34, the system compiles the final completed task information 70 for the first task 33 and the second task 34 into the product development process package 80. The product development process package 80 is then sent to the innovator user account 20 and the second engineer user and the sixth engineer user are compensated for their work.

Although the invention has been explained in relation to its preferred embodiment, it is to be understood that many other possible modifications and variations can be made without departing from the spirit and scope of the invention as hereinafter claimed.

What is claimed is:

1. A method for crowd sourcing product development by executing computer-executable instructions stored on a non-transitory computer-readable medium, the method comprises the steps of:
receiving a product idea submission form through an innovator user account;
assigning a unique identification number to each of a plurality of tasks derived from the product idea submission form;
displaying the plurality of tasks through a release window module;
receiving a plurality of bids for each of the plurality of tasks;
receiving a bid selection corresponding to a particular bid from the plurality of bids for each of the plurality of tasks;
receiving final completed task information for each of the plurality of tasks through a research and development module; and
sending a product development process package to the innovator user account, wherein the product development process package is generated from the final completed task information of each of the plurality of tasks.

2. The method for crowd sourcing product development by executing computer-executable instructions stored on a non-transitory computer-readable medium, the method as claimed in claim 1, wherein the unique identification number is randomly generated.

3. The method for crowd sourcing product development by executing computer-executable instructions stored on a non-transitory computer-readable medium, the method as claimed in claim 1 further comprises the steps of:
identifying the plurality of tasks within the product idea submission form; and
decompiling the product idea submission form into the plurality of tasks.

4. The method for crowd sourcing product development by executing computer-executable instructions stored on a non-transitory computer-readable medium, the method as claimed in claim 1 further comprises the steps of:
receiving decompiling instructions through an administrator user account; and
decompiling the product idea submission form into the plurality of tasks according to the decompiling instructions.

5. The method for crowd sourcing product development by executing computer-executable instruction stored on a non-transitory computer-readable medium, the method as claimed in claim 1 further comprises the steps of:
receiving the plurality of tasks through an administrator user account, wherein the plurality of tasks is determined by an administrator user.

6. The method for crowd sourcing product development by executing computer-executable instructions stored on a non-transitory computer-readable medium, the method as claimed in claim 1, wherein the product idea submission form identifies each of the plurality of tasks.

7. The method for crowd sourcing product development by executing computer-executable instructions stored on a non-transitory computer-readable medium, the method as claimed in claim 1, wherein each of the plurality of bids includes a cost estimate.

8. The method for crowd sourcing product development by executing computer-executable instructions stored on a non-transitory computer-readable medium, the method as claimed in claim 1, wherein each of the plurality of bids includes a time estimate.

9. The method for crowd sourcing product development by executing computer-executable instructions stored on a non-transitory computer-readable medium, the method as claimed in claim 1, wherein each of the plurality of bids includes an initial technical schematic.

10. The method for crowd sourcing product development by executing computer-executable instructions stored on a non-transitory computer-readable medium, the method as claimed in claim 1 further comprises the steps of:
compiling the final completed task information for each of the plurality of tasks into the product development process package.

11. The method for crowd sourcing product development by executing computer-executable instructions stored on a non-transitory computer-readable medium, the method as claimed in claim 9 further comprises the steps of:
receiving compiling instructions through an administrator user account; and
compiling the final completed task information for each of the plurality of tasks into the product development process package according to the compiling instructions.

12. A method for crowd sourcing product development by executing computer-executable instructions stored on a non-transitory computer-readable medium, the method comprises the steps of:
receiving a product idea submission form through an innovator user account;
decompiling the product idea submission form into a plurality of tasks;
randomly generating a unique identification number to each of the plurality of tasks;
displaying the plurality of tasks through a release window module;
receiving a plurality of bids for each of the plurality of tasks;
receiving a bid selection corresponding to a particular bid from the plurality of bids for each of the plurality of tasks;
receiving final completed task information for each of the plurality of tasks through a research and development module;
compiling the final completed task information for each of the plurality of tasks into a product development process package; and
sending the product development process package to the innovator user account.

13. The method for crowd sourcing product development by executing computer-executable instructions stored on a non-transitory computer-readable medium, the method as claimed in claim 12 further comprises the steps of:
identifying the plurality of tasks within the product idea submission form.

14. The method for crowd sourcing product development by executing computer-executable instructions stored on a non-transitory computer-readable medium, the method as claimed in claim 12 further comprises the steps of:
receiving decompiling instructions through an administrator user account; and
decompiling the product idea submission form into the plurality of tasks according to the decompiling instructions.

15. The method for crowd sourcing product development by executing computer-executable instructions stored on a non-transitory computer-readable medium, the method as claimed in claim 12, wherein the product idea submission form identifies each of the plurality of tasks.

16. The method for crowd sourcing product development by executing computer-executable instructions stored on a non-transitory computer-readable medium, the method as claimed in claim 12, wherein each of the plurality of bids includes a cost estimate, a time estimate, and an initial technical schematic.

17. The method for crowd sourcing product development by executing computer-executable instructions stored on a non-transitory computer-readable medium, the method as claimed in claim 12 further comprises the steps of:
receiving compiling instructions through an administrator user account; and
compiling the final completed task information for each of the plurality of tasks into the product development process package according to the compiling instructions.

18. A method for crowd sourcing product development by executing computer-executable instructions stored on a non-transitory computer-readable medium, the method comprises the steps of:
receiving a product idea submission form through an innovator user account;
receiving a plurality of tasks through an administrator user account, wherein the plurality of tasks is determined by an administrator user and derived from the product idea submission form;
randomly generating a unique identification number to each of the plurality of tasks;
displaying the plurality of tasks through a release window module;
receiving a plurality of bids for each of the plurality of tasks;
receiving a bid selection corresponding to a particular bid from the plurality of bids for each of the plurality of tasks;
receiving final completed task information for each of the plurality of tasks through a research and development module;
receiving compiling instructions through an administrator user account;
compiling the final completed task information for each of the plurality of tasks into a product development process package according to the compiling instructions; and
sending the product development process package to the innovator user account.

19. The method for crowd sourcing product development by executing computer-executable instructions stored on a non-transitory computer-readable medium, the method as claimed in claim 18, wherein the product idea submission form identifies each of the plurality of tasks.

20. The method for crowd sourcing product development by executing computer-executable instructions stored on a non-transitory computer-readable medium, the method as claimed in claim 18, wherein each of the plurality of bids includes a cost estimate, a time estimate, and an initial technical schematic.
